(19) United States
(12) Patent Application Publication
(10) Pub. No.: US 2012/0191627 A1
(43) Pub. Date: Jul. 26, 2012

(54) STATE-BASED TRADING MANAGEMENT SYSTEM AND METHOD

(75) Inventor: Yen-Tseng HSU, Taipei City (TW)

(73) Assignee: Gofaser Technology Co., Ltd., Taipei City (TW)

(21) Appl. No.: 13/337,335

(22) Filed: Dec. 27, 2011

(30) Foreign Application Priority Data
Jan. 25, 2011 (TW) 100102559

(51) Int. Cl. G06Q 40/04

(52) U.S. Cl. 705/36 R; 705/37

(57) ABSTRACT

The present invention discloses a state-based trading management system and method. Said trading management system divides each product into at least one type of state(s) to trade. There is one trading strategy relative to each state, including: at least one asset allocation module (model) which provides the ratio of each asset class to the state strategy module (model), and at least one state strategy module (model) performing the relative trading strategies in each state. The said asset allocation module (model) allows supervision from the user or the system itself.

### BACKGROUND OF THE INVENTION

1. Field of the Invention

This present invention relates to a state-based trading management system and method. More specifically, the said invention performs by choosing different trading strategy based on different states of a market. The trading strategy herein may also be referred to “model” or “forecast” method.

The said financial products mentioned in the present art are spots, futures and options products across different sectors including indices, stocks, interest rates, bond, foreign exchange rates, agricultural products, metals, energy products and soft commodities.

2. Description of Related Art

Along with the impact from the internationalization and liberalization on competition of financial market, the asset management industry is currently facing its unprecedented severe challenge, urging global asset management institutions to seek out for solutions and confront this battle. The situation is especially challenging for CTA (Commodity Trading Advisor), also known as managed futures fund. Majority of the CTA suffer from a negative return in 2009, suggesting trend-following strategy being their main focus. In other words, they thrive to capture the market trend; however, when facing market consolidation in the year like 2009, the CTAs who only center trend-following all slumped. FIG. 1 shows a demonstration of trend-following trading. Likewise, if by implementing long only strategy or trade when the market is in consolidation state, it is inevitable to face a bumpy road in the year like 2008 when the market sank dramatically worldwide. Therefore, trading with only one type of strategy in this volatile financial market is indeed risky.

It is difficult to make really precise analysis or prediction on the current market state of a financial product. There is no specific strategy which always makes perfect prediction of the correct market state. This is the object of the present invention, to meet the highly competitive market and shifting environment, we developed a systematic state-based trading management and method, employing different trading strategies by the application of multi categories of states. The trading strategies herein may be referred to “model” or “forecast” method which increases profit and stability effectively.

### SUMMARY OF THE INVENTION

The aim of this invention is to provide a state-based management trading system and method for financial products. The said invention functions by the application of different strategies based on the analysis of multi categories of states. The strategy may be called trading “model” or “forecast” method. The present invention sees financial market as a “state machine” (state mechanism), and the said invention includes financial instrument across different sectors such as index spot and futures, stock spot and futures, interest rate spot and futures, bond spot and futures, foreign exchange rate spot and futures, agricultural spot and futures, metal spot and futures, energy spot and futures, soft commodity spot and futures and all the options of the above instruments.

As shown in the candlestick chart in FIG. 2, section A represents “trend” state, section B stands for “consolidation” state, and the remaining sector unmarked indicates “uncertainty” state. Nevertheless, the states of the said invention do not limited by the above three. Users may form their own definition of states, applying different trading strategies based on its various features in each individual state. The trading strategy herein also refers to model or forecast method, which is used to increase profitability and stability.

The state management system which exercises by the present invention can be divided into “standard state” management system and “dynamic state-driven” management system. In the standard state management system, if a certain financial product mostly is in consolidation and uncertainty state, the system implements trading strategy for both states in the meantime. If the future market is heading to a consolidation state, the chances for consolidation trading strategy to profit increases, and the profitability of corresponding strategy for uncertainty state lowers. On the contrary, when the market is going to an uncertainty, there are higher chances for the uncertainty state strategy to profit, chances for the consolidation strategy to profit is lowered. Accordingly, taking advantage of this combined standard state-based management system, the profitability and stability will be substantially heightened notwithstanding how financial market behaves.

Additionally, in the dynamic state-driven management system, it is designed based on state-driven mechanism. Assuming in a certain market, the majority of the time is in consolidation and uncertainty, after a period of consolidation, chances for uncertainty state to appear thus increases, then trading strategy modules (models) in the “state assessment modules (models)” will send out entry signals to the uncertainty state trading strategy modules (models) of that market, either urge uncertainty strategy modules (models) to increase position, or decrease positions in consolidation strategy modules (models).

Conversely, after a period of uncertainty state, there is higher probability for consolidation state to occur, then the state assessment modules (models) sends the entry signal in the trading strategy modules (models) in consolidation state, either urge consolidation state modules (models) to increase position, or decrease positions in uncertainty state strategy modules (models).

Consequently, through trading with the dynamic state-driven management system in the present invention, investors will be able to enjoy more adaptability and flexibility in trading.

Another objective of the present invention is to offer a complementary trading strategy. According to the features and characteristics of hedge funds, CTA funds, sovereign wealth funds or other categories of asset management funds, we can design complementary trading strategy applying the present invention.

Presumably, if a fund applies trend-following strategy, it is easier to encounter bigger loss during consolidation, enduring high volatility and unstable profitability.

If, by working with the system as the present art, designing a trading strategy that targets to profit in consolidation, so to complete the original strategy of the fund, the drawdown can be lowered substantially, and sharpe ratio will be improved.

In order to offer better understanding of the object, process and functions and demonstrate more of the present invention, further examples and illustrations are demonstrated as follows.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 shows an illustration of trend following trading strategy from prior practices.

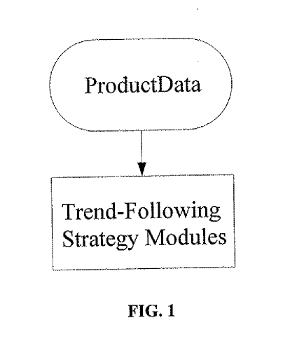

FIG. 2 is the candlestick chart of a financial product.

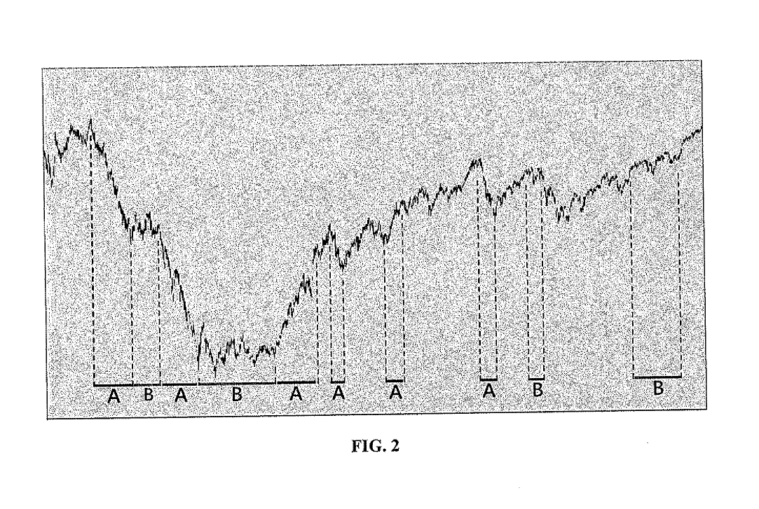

FIG. 3 is an illustration of the state classification in the present state-based trading management as the present invention.

FIG. 4 is a demonstration of trading with multiple states in a single market in the present state-based trading management invention.

FIG. 5 is a demonstration of trading with multiple states in multiple markets in the present state-based trading management invention.

FIG. 6 is an illustration of dynamic state-driven trading in the present state-based trading management invention.

FIG. 7 is an illustration of position adjustment process in the present state-based trading management invention.

### DETAILED DESCRIPTION OF THE PREFERRED EMBODIMENTS

Every financial product contains certain characteristics, some are best described by trend-following, and some are mainly in consolidation. For instance, in the past two decades of Taiwan stock market, we can describe it as “30% trend, 70% consolidation.” As for U.S. stock index S&P 500, during most of the time in its history, it has the repeated cycle of consolidation, upward consolidation and downward consolidation. The cataclysmic crash as in the year 2008 rarely happens. This is somehow related to a market's maturity and features of each individual instrument in different sectors such as indices, stocks, options, bonds, interest rates, agricultural products, foreign exchange rates, energy products and soft commodities. Hence, the present invention separates financial products into several states, and selects the relative trading strategy in accordance with the state. The chosen strategy modules (models) will execute trading.

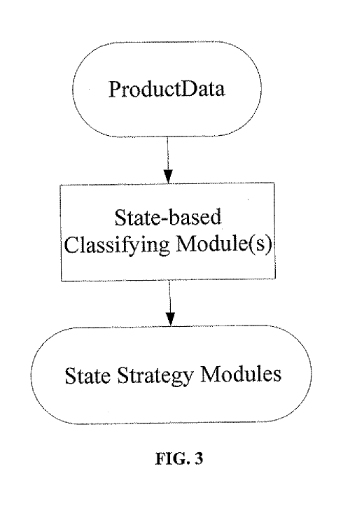

Referring to FIG. 3 on the demonstration which shows a better example of the present invention, it is an illustration of “state classification modules (models)” in the state trading management system. Data of a financial product is entered to the said state classification modules (models) of the presentation. It can be open, high, low and close price of the candlestick chart, or other information related to the said financial product, such as backwardation and contango data, open interest data, volatility of the financial product, or any related prediction of the said product. The state modules (models) classify all related data, and divide the movement of the said product into N states according to users' own settings.

For instance, if the 10-day moving average fluctuates in a certain range (such as within 2%) within certain data interval on the candlestick chart, that said range on the candlestick chart is considered a consolidation state.

Similarly, if the 10-day moving average fluctuates over a certain range (e.g. more than 7%) within certain data interval on the candlestick chart, then the period is regarded as the trend state. As for the rest data interval on the candlestick chart which does not belong to the two states, we define it as uncertain state.

Accordingly, the present invention separates candlestick data interval into three categories, including consolidation, trend and uncertainty states. Nevertheless, the candlestick data interval does not limit to only these three states. Users may set up more states based on their needs, such as upward consolidation state, downward consolidation state, consolidation state, upward trend state, downward trend state, counter-trend state and uncertainty state, etc. After state classification modules (models) source out the states in each financial product, state strategy modules (models) for each category then choose the relative strategy modules (models) according to each state.

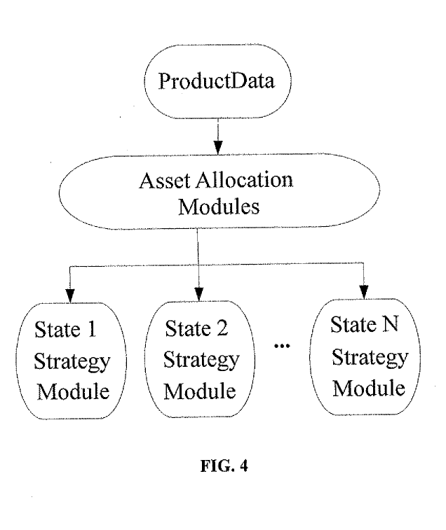

To go further, the present invention applies the standard state management mechanism of the state trading management system shown in FIG. 4 to invest and trade financial products. For example, investment on traditional financial products is traded with single market state, that is, purely trend-following, going long, going short, or simply trade in consolidation. With the present invention, investors are able to trade with multiple strategies, and separate one financial product into several states to trade, for instance, trend, consolidation and uncertainty states. In which, users may apply asset allocation modules (models) to allocate capital in each of the state appropriately. Consequently, no matter how each financial market is going to behave in the future, by applying standard state trading, risk may be diversified, and a stable return may be achieved.

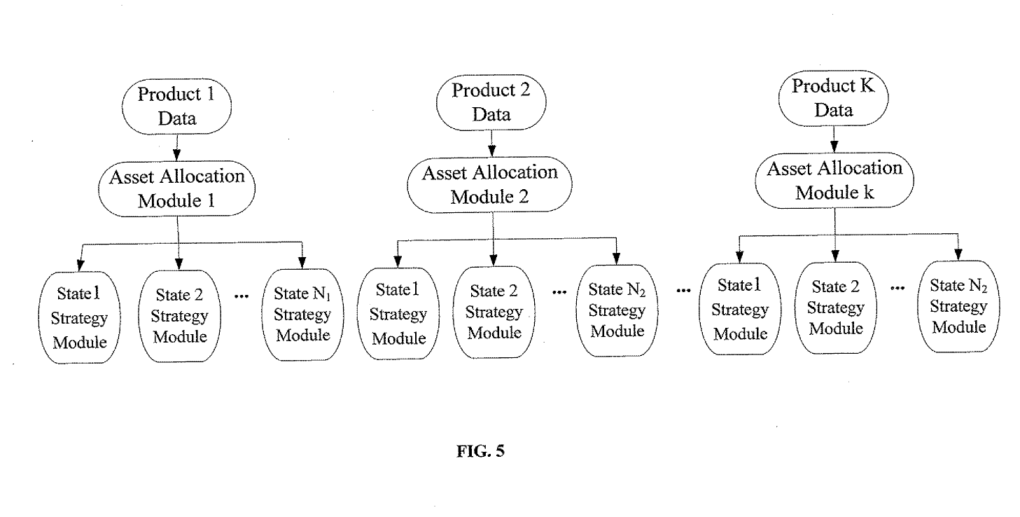

From the above, if there are K financial products, and each with N states, we can apply standard state trading to multiple financial products and trade all simultaneously. As shown in FIG. 5, it is the demonstration of multiple states trading in multiple markets of the present invention. For example, N1 of product 1 can be trend and consolidation states in the meantime, N2 of product 2 can be uncertainty, counter-trend, upward trend and downward trend all four states. Nk of product K can be consolidation, uncertainty, counter-trend, upward trend and downward trend all five states. Users are able to design more states in accordance with different features of each product.

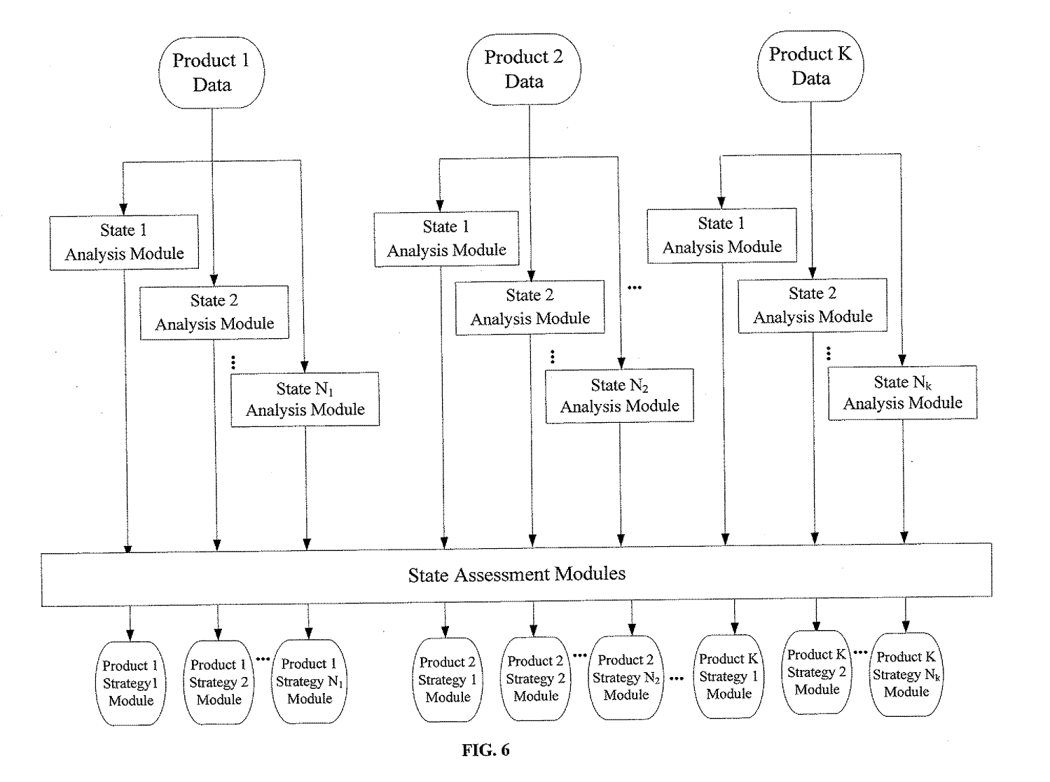

FIG. 6 is a dynamic trading demonstration of the present state trading management system. There are N states within K financial product, likewise, we can design different states such as N1, N2 . . . Nk in terms of different characteristics of each product.

The presented art indeed is capable of managing each state in a financial product dynamically. Nonetheless, each state of every financial product does not have to hold positions at all times. If a certain product comprises two states—consolidation state and trend state, when that product has been through a certain period of consolidation, chances for trend to appear is therefore higher, then the state assessment modules (models) will send entry signal to the strategy modules (models) in trend state of the said product to execute trading.

Likewise, if a certain product has been through an ascending or descending trend, there are bigger chances for consolidation state to appear, therefore state assessment modules (models) send out entry signal to the strategy modules (models) in the consolidation state of the said product. As such, through state-driven trading mechanism of the present dynamic state-based trading management system, risk may be well diversified in each market, while it enhances the stability to profit.

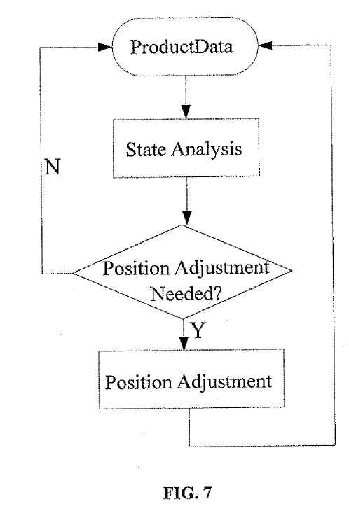

FIG. 7 displays another good example of the present invention, which implements the state analysis of a financial product to adjust positions. Therein, according to the state analysis of the financial product data, the invention can adjust positions based on the prediction of the future state, whether it is going to be in a upward consolidation state, downward consolidation state, consolidation state, upward trend state, downward trend state, trend state, counter-trend state and uncertainty state, or even other self-set states by the users.

For example, trading with the trend state strategy, when trend appears, enter the market, or increase positions; or, when trend state has appeared for a while, decrease positions, or exit market. On the other hand, if we exercise consolidation strategy, when consolidation state occurs, enter and trade, or increase positions; on the contrary, if consolidation state has occurred for a period of time, decrease positions, or exit the market. As a result, by applying the demonstrated dynamic position adjustment of the state, investment managers can be more versatile in trading each financial product.

By the application of state-based trading management system of the present invention, investors should be able to capture behaviors of most of the financial product more precisely, thus choose and modify trading strategy, trading modules (models) or predictions to the most suitable ones for each every financial product.

Although numerous specific examples have been exemplified to assist in an appreciation and understanding of the generic concepts of this disclosure and inventions included therein, the examples are not intended to be limiting with respect to the claims and the scope of the invention.

Anyone whom shall be skilled in the art of the present invention may practice in embodiments other than those illustrated herein without departing from the spirit and scope of the present invention, and that the invention is only limited by the claims which follows.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A state-based trading management system for financial instruments which divides a product into at least one (or one) state to trade, and provides a relative trading strategy to each state, including:
At least one (or one) asset allocation module (model) that offers asset allocation proportion to state-based strategy modules (models); and
At least one (or one) state strategy module (model); each individual state strategy module (model) execute a relative trading strategy in that state.

2. As the stated commodity state-based trading management system claimed in claim 1, therein, the said product refer to index spot and futures, stock spot and futures, interest rate spot and futures, bond spot and futures, foreign exchange rate spot and futures, agricultural spot and futures, metal spot and futures, energy spot and futures, soft commodity spot and futures and all the options of the above instruments.

3. As recited in claim 1, therein, the present state strategy modules (models) may be trend-following modules (models), non trend-following modules (models), uncertainty modules (models), consolidation modules (models), upward consolidation modules (models), downward consolidation modules (models), counter-trend modules (models) or dramatic fluctuation modules (models).

4. As recited in claim 1, therein, the asset allocation modules (models) may be set by the users or managed automatically by the system itself.

5. A state-based trading management system for financial instruments, dividing a product into at least one (or one) state to trade, and provides a relative trading strategy to each state; The main features comprising: The product contains at least one (or one) state-based strategy, each state strategy performs the relative trading strategy in that state.

6. As recited in claim 5, wherein the said state strategy may be referring to trend-following strategy, non trend-following strategy, uncertainty strategy, consolidation strategy, upward consolidation strategy, downward consolidation strategy, counter-trend strategy or strategy dealing with dramatic fluctuation.

7. As recited in claim 5, wherein the said product may be index spot and futures, stock spot and futures, interest rate spot and futures, bond spot and futures, foreign exchange rate spot and futures, agricultural spot and futures, metal spot and futures, energy spot and futures, soft commodity spot and futures and all the options of the above instruments.

8. A state-based trading management system for financial instruments, including:
at least one (or one) state analysis module (models), each state analysis module (model) receives product data so as to analyze its state, sends the result to a state assessment module (model); and
at least one State Strategy module (model), determining whether to exercise the relative trading strategies in each state of a product or not in accordance with the data state analyzed by state analysis modules (models); and at least one product strategy module (model), performing the corresponding strategy of each current state of a product.

9. As recited in claim 8, the state analysis modules (models) therein may be trend-following state analysis, non trend-following state analysis, and uncertainty state analysis, consolidation state analysis, ascending consolidation state analysis, descending consolidation state analysis, counter-trend state analysis or analysis to dramatic fluctuation state.

10. As recited in claim 8, the said state assessment module (models) of the present state-based trading management system further comprises functions such as position management, weight distribution, risk management or volatility control.

11. As recited in claim 8, the said product strategy modules (models) may represents trend-following state trading strategy, non trend-following state trading strategy, uncertainty state trading strategy, consolidation state trading strategy, upward consolidation state trading strategy, downward consolidation state trading strategy, counter-trend state trading strategy or dramatic fluctuation state trading strategy.

12. As recited in claim 8, the said product of the present state-based trading management system for financial instrument may be referring to index spot and futures, stock spot and futures, interest rate spot and futures, bond spot and futures, foreign exchange rate spot and futures, agricultural spot and futures, metal spot and futures, energy spot and futures, soft commodity spot and futures and all the options of the above instruments.

13. A state-based management method for trading, comprising:
A state-based analysis approach which receives product data to analyze the current market state in order to provide data analysis for entry signal, exit signal and position management; and
a trading analysis approach which based on the result of state analysis, judging whether to enter/exit market, increase/decrease positions, and a mean to adjust positions, to receive outcome from trading evaluation approach, then to execute trading, e.g. enter or exit market, increase or decrease positions.
